(19) United States
(12) Patent Application Publication
(10) Pub. No.: US 2017/0155690 A1
(43) Pub. Date: Jun. 1, 2017

(54) Video Communication Ending Method and Apparatus, and Storage Medium

(71) Applicant: Xiaomi Inc., Beijing (CN)

(72) Inventors: Xiong ZHAO, Beijing (CN); Heng SUN, Beijing (CN); Shangui LIANG, Beijing (CN)

(73) Assignee: Xiaomi Inc., Beijing (CN)

(21) Appl. No.: 15/363,783

(22) Filed: Nov. 29, 2016

(30) Foreign Application Priority Data
Nov. 30, 2015 (CN) 201510853922.1

(51) Int. Cl. H04L 29/06; H04N 7/14; H04L 12/24

(52) U.S. Cl. CPC H04L 65/1013; H04L 65/403; H04L 41/06; H04N 7/147

(57) ABSTRACT

A method, an apparatus, and a storage medium are provided for ending video communication. The method includes: detecting whether a first end button is clicked by a user during the video communication between the electronic device and a counterpart device; sending network failure prompt information to a counterpart device when detecting that the user clicks the first end button; sending a disconnection request to the counterpart device to disconnect video communication with the counterpart device.

### CROSS-REFERENCE TO RELATED APPLICATION

The application is based on and claims the priority of the Chinese Patent Application No. 201510853922.1, filed on Nov. 30, 2015, which is incorporated herein by reference in its entirety.

### TECHNICAL FIELD

The present disclosure relates to the field of communication technology, and more particularly, to a video communication ending method and apparatus, and a storage medium.

### BACKGROUND

With the continuous development of communication technology, video communication between users via a network has become a popular way of communication. By virtue of video communications, a user may not only see his/her communication counterpart's head portrait, but also perform voice communication with the counterpart.

When a user wants to end video communication with another user, the only way is to directly click the close button on the video communication interface. Then, it shows on the other user's video communication interface that the counterpart has hung up. Subsequently, the video communication between the users is disconnected and ended.

The way of ending video communication lacks flexibility, since there is only one way to end the video communication.

### SUMMARY

According to one aspect of embodiments of this disclosure, a method is provided for ending a video communication. In the method, an electronic device detects whether a first end button is clicked by a user during the video communication between the electronic device and a counterpart device. The electronic device sends network failure prompt information to the counterpart device when detecting that the user clicks the first end button. The electronic device sends a disconnection request the counterpart device to disconnect the video communication with the counterpart device.

According to another aspect of embodiments of this disclosure, a video communication ending apparatus is provided. The apparatus includes: a detection module configured to detect whether a first end button is clicked by a user; a sending module configured to send a network failure prompt information to a counterpart device when the user clicks the first end button and to send a disconnection request to the counterpart device in order to disconnect the video communication with the counterpart device.

According to yet another aspect of embodiments of this disclosure, there is provided a non-transitory computer-readable storage medium having stored therein instructions that, when executed by a processor of a mobile terminal, causes the mobile terminal to perform video communication ending method, the method comprising: detecting whether a first end button is clicked by a user; sending network failure prompt information to a counterpart device if the user clicks the first end button; and sending a disconnection request the counterpart device in order to disconnect video communication with the counterpart device.

It is to be understood that both the foregoing general description and the following detailed description are exemplary and explanatory only and are not restrictive of the disclosure.

### BRIEF DESCRIPTION OF THE DRAWINGS

FIG. 1 is a flowchart of a method for ending video communication according to an exemplary embodiment of this disclosure;

FIG. 2 is a structure view of a video communication ending apparatus according to an exemplary embodiment of this disclosure; and

FIG. 3 is a structure view of a video communication ending apparatus according to another exemplary embodiment of this disclosure.

### DETAILED DESCRIPTION

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

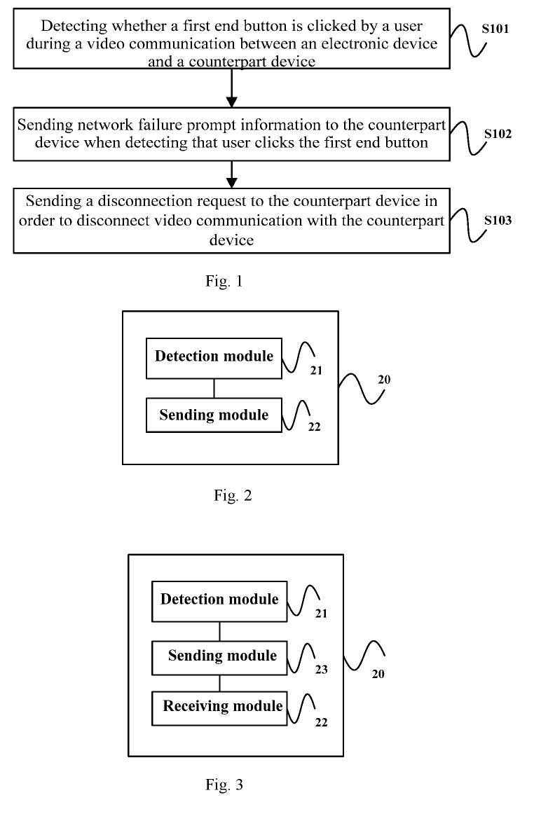

FIG. 1 is a flowchart of a method for ending video communication according to an exemplary embodiment of this disclosure. The method may be implemented in an electronic device having a video conference function. The method includes the following steps.

In step 101, it is detected whether a first end button is clicked by a user. For example, the electronic device may detect whether a first end button in a user interface facilitating the video communication is clicked by the user. The first end button may be defined by a user using the video communication application or the setting of the electronic device. The user may define a physical button on the electronic device to act as the first end button in some embodiments.

The video communication ending method provided by the embodiments of the present disclosure is executed by a video communication ending apparatus which is arranged in a device such as a personal computer, a mobile terminal, a portable computer, etc. Taking the mobile terminal as an example, two users (for example, user A and user B) use their own mobile terminals to perform video communication. When user A and user B are performing video communication with each other, video communication interfaces are respectively shown on screens of the mobile terminals. There are at least two end buttons on each of the video communication interfaces. When the video communication interfaces include two buttons, one may be the close button, and the other may be the first end button of the embodiment of this disclosure. When user A clicks the close button on the screen of his/her mobile terminal, the video communication with the mobile terminal of user B is disconnected.

In the embodiment of this disclosure, user A acts as the party who actively ends the video communication. The video communication ending apparatus in the mobile terminal of user A detects whether the first end button is clicked by user A in real time.

In step 102, network failure prompt information is sent to a counterpart device if the user clicks the first end button. Alternatively or additionally, the communication ending apparatus may send the same network failure message or additional failure message to a server or gateway connected to both the communication ending apparatus and the counterpart device. The counterpart device may then show the network failure message on its user interface.

If the video communication ending apparatus in the mobile terminal of user A detects that the first end button is clicked by user A, network failure prompt information is sent to the mobile terminal of user B. The network failure prompt information specifically prompts network interruption, failure of user A's network, failure of user B's network or the like. Therefore, the counterpart device may show corresponding error message on the user interface after receiving the failure prompt information. Accordingly, user B thinks a network failure causes interruption of video communication with user A.

In step 103, a disconnection request is sent to the counterpart device in order to disconnect the video communication with the counterpart device. The communication ending apparatus may send the disconnection request directly to the counterpart device or send it to a server/gate way that provides the video communication service.

After the video communication ending apparatus in the mobile terminal of user A sends network failure prompt information to the mobile terminal of user B, the video communication ending apparatus subsequently sends a disconnection request to the mobile terminal of user B, so that the video communication connection between user A and user B can be disconnected. Signaling interaction between the two mobile terminals involved in the disconnection process of video communication is consistent with that of prior art.

In the disclosure, a new end button is added, and network failure prompt information is sent to the counterpart device after a user clicks the new end button, so that the user of the counterpart device considers that a network failure causes the interruption of video communication. As compared with the conventional way of ending video communication in which a close button on the video communication interface of one user is directly clicked and it is shown on the video communication interface of the other user that the counterpart has hung up, the flexibility of ending video communication is increased.

On the basis the above embodiment, the video communication ending method further includes: detecting whether a second end button is clicked by the user; sending user-request-disconnection information to the counterpart device when the user clicks the second end button, so that confirm-user-disconnection information is generated by the counterpart device according to a confirmation of the user-request-disconnection information by a user of the counterpart device; and receiving the confirm-user-disconnection information sent by the counterpart device.

In one or more embodiments of this disclosure, there are three end buttons displayed in the video communication interface. One is the close button, the second one is the first end button of the above embodiment, and the third one is the second end button of this embodiment of the disclosure. For example, user A acts as the party who actively ends the video communication. The video communication ending apparatus in the mobile terminal of user A detects whether the second end button is clicked by user A in real time. If the video communication ending apparatus in the mobile terminal of user A detects that the second end button is clicked by user A, disconnection request information, such as user A-request-disconnection information, is sent to the mobile terminal of user B. User B confirms by clicking according to the user A-request-disconnection information. The mobile terminal of user B generates confirm-user-disconnection information according to the click-to-confirm operation, and sends the confirm-user-disconnection information to the mobile terminal of user A.

The sending the disconnection request to the counterpart device in order to disconnect the video communication with the counterpart device includes: sending the disconnection request to the counterpart device according to the confirm-user-disconnection information in order to disconnect the video communication with the counterpart device.

The mobile terminal of user A sends a disconnection request to the mobile terminal of user B after receiving the confirm-user-disconnection information, in order to disconnect the video communication with the mobile terminal of user B.

After sending the disconnection request to the counterpart device in order to disconnect the video communication with the counterpart device, the methods further includes: receiving a connection setup request sent by the counterpart device; and discarding the connection setup request and sending the network failure prompt information to the counterpart device.

During a period of time after the video communication between the mobile terminal of user A and the mobile terminal of user B is disconnected, if the mobile terminal of user B initiates a connection setup request to the mobile terminal of user A in order to setup video communication again with the mobile terminal of user A, the video communication ending apparatus in the mobile terminal of user A discards the connection setup request after receiving it, and sends the network failure prompt information in the above embodiment to the mobile terminal of user B, so that user B considers that a network failure makes the video communication with user B unable to be set up again.

The step of receiving the connection setup request sent by the counterpart device includes: receiving a plurality of connection setup requests sent by the counterpart device in a preset period of time. The step of discarding the connection setup request and sending the network failure prompt information to the counterpart device includes: discarding each of the plurality of connection setup requests and meanwhile sending the network failure prompt information to the counterpart device.

During a period of time after the video communication between the mobile terminals of user A and user B is disconnected, the mobile terminal of user B may initiate a plurality of connection setup requests to the mobile terminal of user A. For each of the connection setup requests, the video communication ending apparatus in the mobile terminal of user A discards the connection setup request, and sends the network failure prompt information of the above embodiment to the mobile terminal of user B, so that user B considers that a network failure makes the video communication with user A unable to be set up again.

In the one or more embodiments of the disclosure, an additional new end button is added, and user-request-disconnection information is sent to the counterpart device after a user clicks the additional new end button, in order to request the counterpart device's approval to interrupt video communication, thereby improving the flexibility of ending video communication. Moreover, the flexibility of ending video communication is further increased by discarding the connection setup request sent by the counterpart device and sending the network failure prompt information to the counterpart device, so that the user of the counterpart device considers that a network failure makes the video communication with user A unable to be set up again.

FIG. 2 is a structure view of a video communication ending apparatus according to an embodiment of this disclosure. The video communication ending apparatus provided in the embodiment of this disclosure may execute the process flow provided by the embodiment of video communication ending method. As shown in FIG. 2, the video communication ending apparatus 20 includes a detection module 21 and a sending module 22. The detection module 21 is configured to detect whether a first end button is clicked by a user. The sending module 22 is configured to send network failure prompt information to a counterpart device when the user clicks the first end button and to send a disconnection request to the counterpart device in order to disconnect the video communication with the counterpart device.

In one or more embodiments of the disclosure, a new end button is added, and network failure prompt information is sent to the counterpart device after a user clicks the new end button, so that the user of counterpart device considers that a network failure causes the interruption of video communication. As compared with the conventional way of ending video communication in which a close button on the video communication interface of one user is directly clicked and it is shown on the video communication interface of the other user that the counterpart has hung up, the flexibility of ending video communication is increased.

FIG. 3 is a structure view of a video communication ending apparatus according to another embodiment of this disclosure. Based on the above embodiment, the detection module 21 is further configured to detect whether a second end button is clicked by the user. The sending module 22 is further configured to send user-request-disconnection information to the counterpart device if the user clicks the second end button, so that confirm-user-disconnection information is generated by the counterpart device according to a confirmation of the user-request-disconnection information by a user of the counterpart device. The video communication ending apparatus further includes a receiving module 23 configured to receive the confirm-user-disconnection information sent by the counterpart device.

The sending module 22 is configured to send a disconnection request to the counterpart device according to the confirm-user-disconnection information in order to disconnect the video communication with the counterpart device.

The receiving module 23 is further configured to receive a connection setup request sent by the counterpart device and discard the connection setup request. The sending module 22 is further configured to send the network failure prompt information to the counterpart device.

The receiving module 23 is configured to receive a plurality of connection setup requests sent by the counterpart device in a preset period of time and discard each of the plurality of connection setup requests. The sending module 22 is configured to send the network failure prompt information to the counterpart device while the receiving module 23 discards the connection setup request.

The video communication ending apparatus provided in the embodiment of this disclosure may be configured to execute the method embodiment provided in FIG. 1, and the specific functions thereof are omitted here.

In one or more embodiments of this disclosure, a new end button is added, and network failure prompt information is sent to the counterpart device after a user clicks the new end button, in order to request the counterpart device's approval to interrupt video communication, thereby improving the flexibility of ending video communication. Moreover, the flexibility of ending video communication is further increased by discarding the connection setup request sent by the counterpart device and sending the network failure prompt information to the counterpart device, so that the user of the counterpart device considers that a network failure makes the video communication with user A unable to be set up again. Although video communication is used as an example, the above methods may be used to end any communication involving two or more electronic devices so that one of the devices may send an error message indicating a connection error to other devices when detecting a new end button is clicked.

To sum up, in the embodiments of the disclosure, a new end button is added, and network failure prompt information is sent to the counterpart device after a user clicks the new end button, so that the user of the counterpart device considers that a network failure causes the interruption of video communication. As compared with the conventional way of ending video communication in which a close button on the video communication interface of one user is directly clicked and it is shown on the video communication interface of the other user that the counterpart has hung up, the flexibility of ending video communication is increased. By adding an additional new end button and, after a user clicks the additional new end button, sending user-request-disconnection information to the counterpart device in order to request the counterpart device's approval to interrupt video communication, the flexibility of ending video communication is further increased. Moreover, the flexibility of ending video communication is further improved by discarding the connection setup request sent by the counterpart device and sending the network failure prompt information to the counterpart device, so that the user of the counterpart device considers that a network failure makes the video communication with user A unable to be set up again.

It will be appreciated that the apparatus and methods disclosed in this disclosure can be implemented in other ways. For example, the apparatus embodiments described above are exemplary. For example, the division into the units is just a kind of logical function division. There are additional division ways in actual implementation. For example, a plurality of units or components may be combined or integrated into another system, or some feature can be omitted or not executed. For another thing, the displayed or discussed coupling or direct coupling or communication connection may be indirect coupling or communication connection through some interfaces, apparatuses or units, and may be electrical, mechanical or in other forms.

The units explained as separate components may or may not be separated physically. The components displayed as units may or may not be physical units, that is, may be located in one place or distributed across a plurality of network units. The object of embodiments of this disclosure can be achieved by selecting part or all of the units according to actual needs.

In addition, the various functional units of various embodiments can be integrated into one processor or can be implemented by separate circuitry units. Here, two or more units may be integrated into one unit. The above integrated units can be realized in hardware or the combination of hardware and software.

The integrated units implemented in the form of software function units may be stored in a computer readable storage medium. The software function units are stored in storage medium, and include several instructions causing a computer device (such as personal computer, server or network device, etc.) or processor to execute parts of steps of the method according to embodiments of the disclosure. The above storage medium includes medium which can store program code, such as USB flash disk, removable hard disk, Read-Only Memory (ROM), Random Access Memory (RAM), magnetic disk or optical disk, etc.

Those skilled in the art may clearly appreciate that the above division into various functional modules is exemplary for the sake of convenient and concise description. In practical application, the above functions may be implemented by different functional modules as needed. That is, the internal structure of apparatus may be divided into different functional modules to implement all or part functions described above. For the specific workflow of the apparatus described above, reference can be made to the corresponding process of above method embodiments and the description thereof is omitted here.

The modules may be implemented using one or more circuitries, integrated circuit chips, etc. For example, the function modules may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components.

It will be appreciated that the above various embodiments are used only for illustrating the technical solution of this disclosure but not for limiting. Although the disclosure is explained in detail with reference to the embodiments, the skilled in the art should appreciate that various modifications can be made to the technical solutions recited in the above various embodiments or equivalent replacements can be made to part or all of technical features of the technical solutions, without departing from the scope of technical solutions of various embodiments of this disclosure.

1. A method for ending a video communication, comprising:
detecting, by an electronic device, whether a first end button is clicked by a user during the video communication between the electronic device and a counterpart device;
sending network failure prompt information to the counterpart device when detecting that the user clicks the first end button; and
sending a disconnection request to the counterpart device to end the video communication with the counterpart device.

2. The method according to claim 1, further comprising:
detecting whether a second end button is clicked by the user during the video communication;
sending user-request-disconnection information to the counterpart device when detecting that the user clicks the second end button, so that confirm-user-disconnection information is generated by the counterpart device according to a confirmation of the user-request-disconnection information by a user of the counterpart device; and
receiving the confirm-user-disconnection information sent by the counterpart device.

3. The method according to claim 2, wherein sending the disconnection request to the counterpart device to disconnect the video communication with the counterpart device comprises:
sending the disconnection request to the counterpart device according to the confirm-user-disconnection information to disconnect the video communication with the counterpart device.

4. The method according to claim 1, wherein after sending the disconnection request to the counterpart device to disconnect the video communication with the counterpart device, the method further comprises:
receiving a connection setup request sent by the counterpart device; and
discarding the connection setup request and sending the network failure prompt information to the counterpart device.

5. The method according to claim 2, wherein after sending the disconnection request to the counterpart device to disconnect the video communication with the counterpart device, the method further comprises:
receiving a connection setup request sent by the counterpart device; and
discarding the connection setup request and sending the network failure prompt information to the counterpart device.

6. The method according to claim 3, wherein after sending the disconnection request to the counterpart device to disconnect the video communication with the counterpart device, the method further comprises:
receiving a connection setup request sent by the counterpart device; and
discarding the connection setup request and sending the network failure prompt information to the counterpart device.

7. The method according to claim 4, wherein receiving the connection setup request sent by the counterpart device comprises: receiving a plurality of connection setup requests sent by the counterpart device in a preset period of time; and
wherein discarding the connection setup request and sending the network failure prompt information to the counterpart device comprises: discarding each of the plurality of connection setup requests and meanwhile sending the network failure prompt information to the counterpart device.

8. The method according to claim 5, wherein receiving the connection setup request sent by the counterpart device comprises: receiving a plurality of connection setup requests sent by the counterpart device in a preset period of time; and
wherein discarding the connection setup request and sending the network failure prompt information to the counterpart device comprises: discarding each of the plurality of connection setup requests and meanwhile sending the network failure prompt information to the counterpart device.

9. The method according to claim 6, wherein receiving the connection setup request sent by the counterpart device comprises: receiving a plurality of connection setup requests sent by the counterpart device in a preset period of time; and
wherein discarding the connection setup request and sending the network failure prompt information to the counterpart device comprises: discarding each of the plurality of connection setup requests and meanwhile sending the network failure prompt information to the counterpart device.

10. An apparatus, comprising:
a processor; and
a memory configured to store instructions executable by the processor, wherein the processor is configured to:
detect whether a first end button is clicked by a user during a video communication between the apparatus and a counterpart device;
send network failure prompt information to the counterpart device when detecting that the user clicks the first end button; and
send a disconnection request the counterpart device to disconnect video communication with the counterpart device.

11. The apparatus of claim 10, wherein the processor is further configured to:
detect whether a second end button is clicked by the user during the video communication;
send user-request-disconnection information to the counterpart device when detecting that the user clicks the second end button, so that confirm-user-disconnection information is generated by the counterpart device according to a confirmation of the user-request-disconnection information by a user of the counterpart device; and
receive the confirm-user-disconnection information sent by the counterpart device.

12. The apparatus of claim 11, wherein the processor is further configured to: send the disconnection request to the counterpart device according to the confirm-user-disconnection information to disconnect the video communication with the counterpart device.

13. The apparatus of claim 10, wherein the processor is further configured to: after sending the disconnection request to the counterpart device to disconnect the video communication with the counterpart device, receive a connection setup request sent by the counterpart device, and discard the connection setup request and sending the network failure prompt information to the counterpart device.

14. The apparatus of claim 11, wherein the processor is further configured to: after sending the disconnection request to the counterpart device to disconnect the video communication with the counterpart device, receive a connection setup request sent by the counterpart device, and discard the connection setup request and sending the network failure prompt information to the counterpart device.

15. The apparatus of claim 12, wherein the processor is further configured to: after sending the disconnection request to the counterpart device to disconnect the video communication with the counterpart device, receive a connection setup request sent by the counterpart device, and discard the connection setup request and sending the network failure prompt information to the counterpart device.

16. The apparatus of claim 13, wherein the processor is further configured to: receive a plurality of connection setup requests sent by the counterpart device in a preset period of time, and discard each of the plurality of connection setup requests and meanwhile sending the network failure prompt information to the counterpart device.

17. The apparatus of claim 14, wherein the processor is further configured to: receive a plurality of connection setup requests sent by the counterpart device in a preset period of time, and discard each of the plurality of connection setup requests and meanwhile sending the network failure prompt information to the counterpart device.

18. The apparatus of claim 15, wherein the processor is further configured to: receive a plurality of connection setup requests sent by the counterpart device in a preset period of time, and discard each of the plurality of connection setup requests and meanwhile sending the network failure prompt information to the counterpart device.

19. A non-transitory computer-readable storage medium having stored therein instructions that, when executed by a processor of a mobile terminal, causes the mobile terminal to perform acts comprising:
detecting whether a first end button is clicked by a user during a video communication;
sending network failure prompt information to a counterpart device when detecting that the user clicks the first end button; and
sending a disconnection request the counterpart device to disconnect video communication with the counterpart device.

20. The storage medium of claim 19, wherein the method further comprises:
detecting whether a second end button is clicked by the user during the video communication;
sending user-request-disconnection information to the counterpart device when detecting that the user clicks the second end button, so that confirm-user-disconnection information is generated by the counterpart device according to a confirmation of the user-request-disconnection information by a user of the counterpart device; and
receiving the confirm-user-disconnection information sent by the counterpart device.
